(19) United States
(12) Patent Application Publication
(10) Pub. No.: US 2026/0058359 A1
(43) Pub. Date: Feb. 26, 2026

(54) LIGHTNING PROTECTION STRUCTURE ADAPTED FOR ANTENNA END OF FILTER

(71) Applicant: Suzhou Luxshare Technology Co., Ltd., Suzhou City (CN)

(72) Inventors: Wei WANG, Suzhou City (CN); Xiang XIAO, Suzhou City (CN); Xing-Hua SUN, Suzhou City (CN)

(73) Assignee: Suzhou Luxshare Technology Co., Ltd., Suzhou City (CN)

(21) Appl. No.: 19/246,342

(22) Filed: Jun. 23, 2025

(30) Foreign Application Priority Data
Aug. 20, 2024 (CN) 202422018624.8

(51) Int. Cl. H01Q 1/50; H02G 13/00

(52) U.S. Cl. CPC H01Q 1/50; H02G 13/80

(57) ABSTRACT

A lightning protection structure includes an antenna jointing interface, a main jointing rod, a cavity filter, a printed circuit board, an induction coil and a notch filter. The main jointing rod passes through a wall surface of the cavity filter. The main jointing rod is coupled to the antenna jointing interface. The induction coil is arranged in the notch filter. The induction coil includes a spiral body portion, a first end portion and a second end portion. The first end portion and the second end portion extend from the spiral body portion in opposite directions. The first end portion of the induction coil extends through the top cover of the notch filter. The first end portion of the induction coil is coupled to the printed circuit board. The second end portion of the induction coil is coupled to a bottom wall of the notch filter.

### CROSS-REFERENCE TO RELATED APPLICATION

This patent application claims priority of a Chinese Patent Application No. 202422018624.8, filed on Aug. 20, 2024 and titled “LIGHTNING PROTECTION STRUCTURE ADAPTED FOR ANTENNA END OF FILTER”, the entire content of which is incorporated herein by reference.

### TECHNICAL FIELD

The present disclosure relates to a field of communication, in particular to a lightning protection structure adapted for an antenna end of a filter.

### BACKGROUND

Cavity filters are installed on communication base stations and usually need to be well protected against lightning. Therefore, the cavity filters are generally designed with lightning protection structures at the antenna ends of the filters. However, in a related art, referring to FIGS. 1 to 3, the lightning protection structure at an antenna end of the filter includes an induction coil, a printed circuit board, a cavity filter, an antenna jointing interface, a notch filter and a coupling rod coupled to the antenna jointing interface. The notch filter has a central column that extends vertically and is coupled to the printed circuit board. The induction coil is transversely connected between the notch filter and the coupling rod.

### SUMMARY

The present disclosure adopts a first technical solution: a lightning protection structure includes an antenna jointing interface, a main jointing rod, a cavity filter, a printed circuit board, an induction coil and a notch filter. The antenna jointing interface is located outside the cavity filter. All of the main jointing rod, the printed circuit board and the notch filter are located in the cavity filter. The main jointing rod passes through a wall surface of the cavity filter and the main jointing rod is coupled to the antenna jointing interface. The printed circuit board and the notch filter are respectively positioned at two opposite sides of the main jointing rod. The induction coil is arranged in the notch filter. The induction coil includes a spiral body portion, a first end portion and a second end portion. The first end portion and the second end portion extend from the spiral body portion in two opposite directions. The first end portion of the induction coil penetrates the top cover of the notch filter and the first end portion of the induction coil is coupled to the printed circuit board. The second end portion of the induction coil is coupled to a bottom wall of the notch filter which is opposite to the top cover.

The present disclosure adopts a second technical solution: a lightning protection structure includes an antenna jointing interface, a main jointing rod, a cavity filter, a printed circuit board, an induction coil and a notch filter. The antenna jointing interface is located outside the cavity filter. The main jointing rod is located in the cavity filter. The main jointing rod passes through a wall surface of the cavity filter and the main jointing rod is coupled to the antenna jointing interface. The printed circuit board and the notch filter are both located in the cavity filter and respectively positioned at two opposite sides of the main jointing rod. The induction coil is arranged in the notch filter. The induction coil includes a spiral body portion, a first end portion and a second end portion. The first end portion and the second end portion extend from the spiral body portion in two opposite directions. The first end portion of the induction coil penetrates the top cover of the notch filter and the first end portion of the induction coil is coupled to the printed circuit board. The second end portion of the induction coil is coupled to a bottom wall of the notch filter which is opposite to the top cover.

The present disclosure adopts a third technical solution: a lightning protection structure includes an antenna jointing interface, a main jointing rod, a cavity filter, a printed circuit board, an induction coil and a notch filter. The antenna jointing interface is located outside the cavity filter. The main jointing rod is located in the cavity filter. The main jointing rod passes through a wall surface of the cavity filter and the main jointing rod is coupled to the antenna jointing interface. The printed circuit board is located in the cavity filter. The printed circuit board is positioned at a first lateral side of the main jointing rod. The notch filter is located in the cavity filter. The notch filter is positioned at a second lateral side of the main jointing rod which is opposite to the first lateral side of the main jointing rod. The induction coil is arranged in the notch filter. The induction coil includes a spiral body portion, a first end portion and a second end portion. The first end portion extending from the spiral body portion in a first direction and the second end portion extending from the spiral body portion in a second direction opposite to the first direction. The first end portion of the induction coil penetrates the top cover of the notch filter and the first end portion of the induction coil is coupled to the printed circuit board. The second end portion of the induction coil is coupled to a bottom wall of the notch filter which is opposite to the top cover.

### BRIEF DESCRIPTION OF DRAWINGS

FIG. 1 is a top view of a lightning protection structure adapted for an antenna end of a filter in accordance with a related art;

FIG. 2 is a side view of the lightning protection structure adapted for the antenna end of the filter of FIG. 1;

FIG. 3 is a cross-sectional view taken along line A-A in FIG. 2;

FIG. 4 is a top view of a lightning protection structure adapted for an antenna end of a filter in accordance with an embodiment of the present disclosure;

FIG. 5 is an enlarged view of part B in FIG. 4;

FIG. 6 is a cross-sectional view taken along line C-C in FIG. 5;

FIG. 7 is a perspective, exploded view of the lightning protection structure adapted for the antenna end of the filter of FIG. 4; and

FIG. 8 is an enlarged view of part D in FIG. 7.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

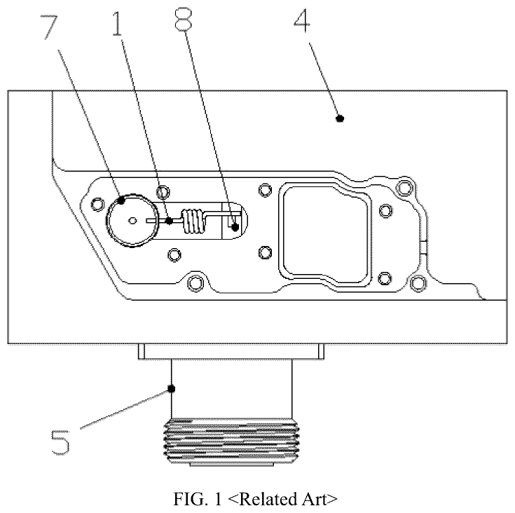

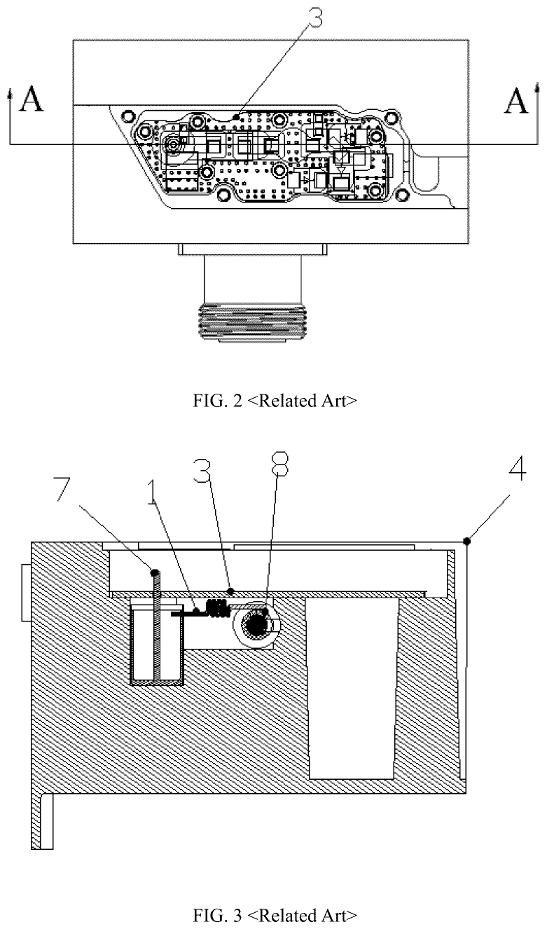

Because a related art which is shown in FIGS. 1-3 adopts a bar turning processing, the lightning protection structure at the antenna end of the filter has a “deep” plus “narrow” cavity space and furthermore, because some conditions may occur in the production of the central column, such as easy deformation and bending, poor diameter and so on, the production yield of the central column is not high and so, the processing efficiency of the lightning protection structure at the antenna end of the filter is low. The abovementioned occurred conditions induce that the central column cannot be repaired or replaced separately, and an automatic batch processing cannot be realized. Because the central column and a shell of the notch filter are integrated structures, the bottom of the inner cavity is easy to produce electroplating black lines or spots during electroplating, which is not easy to clean and repair. The central column and the shell of the notch filter need “hanging plating” treatment, and the electroplating cost is 2 to 3 times that of “barrel plating”. Therefore, a processing efficiency of the lightning protection structure at the antenna end of the related art is low, a maintenance difficulty of the lightning protection structure at the antenna end of the related art is large, and a replacement cost of the lightning protection structure at the antenna end of the related art is high.

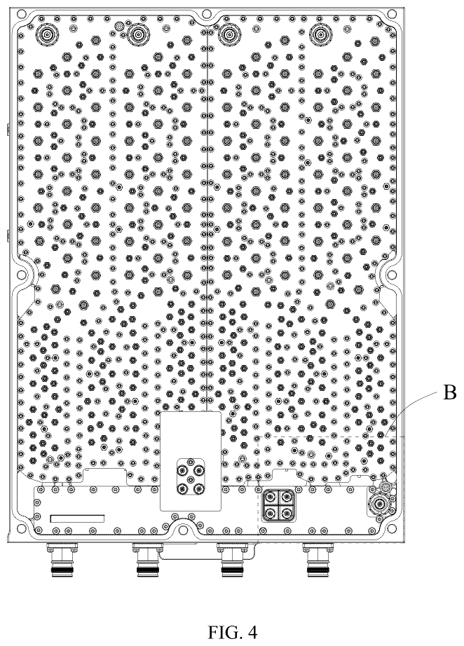

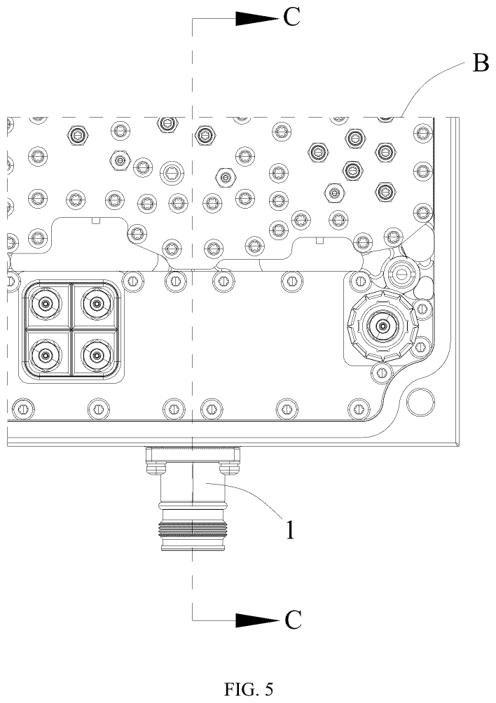

Referring to FIGS. 4 to 8, the present disclosure discloses a lightning protection structure adapted for an antenna end of a filter. The lightning protection structure includes an antenna jointing interface 1, a main jointing rod 2, a cavity filter 3, a printed circuit board 4, an induction coil 5 and a notch filter 6. The antenna jointing interface 1 is located outside the cavity filter 3. The main jointing rod 2, the printed circuit board 4 and the notch filter 6 are all located in the cavity filter 3. The main jointing rod 2 passes through the wall surface of the cavity filter 3 and the main jointing rod 2 is coupled to the antenna jointing interface 1. The printed circuit board 4 and the notch filter 6 are respectively positioned at two opposite sides of the main jointing rod 2 (In other words, the printed circuit board 4 is positioned at a first lateral side of the main jointing rod 2 and the notch filter 6 is positioned at a second lateral side of the main jointing rod 2 which is opposite to the first lateral side of the main jointing rod 2). The induction coil 5 is arranged in the notch filter 6. The induction coil 5 includes a spiral body portion 50, a first end portion 51 and a second end portion 52. The first end portion 51 and the second end portion 52 extend from the spiral body portion 50 in two opposite directions (In other words, the first end portion 51 extends from the spiral body portion 50 in a first direction and the second end portion 52 extends from the spiral body portion 50 in a second direction opposite to the first direction). The notch filter 6 includes a top cover 60. The first end portion 51 of the induction coil 5 penetrates the top cover 60 of the notch filter 6 and the first end portion 51 of the induction coil 5 is coupled to the printed circuit board 4. The second end portion 52 of the induction coil 5 is coupled to a bottom wall of the notch filter 6 which is opposite to the top cover 60.

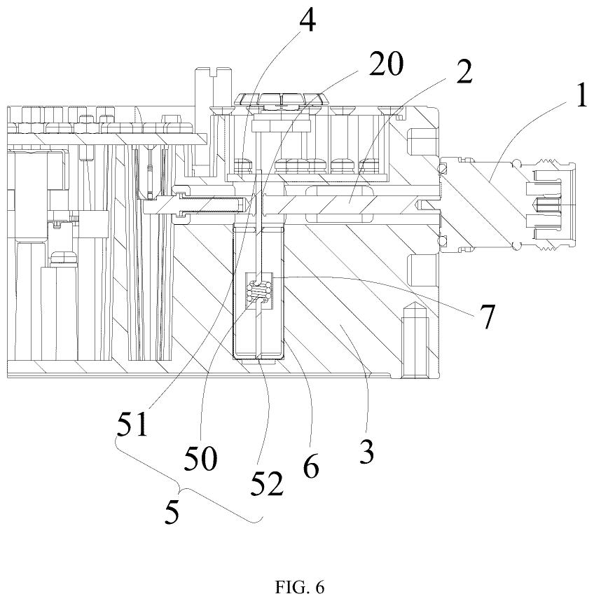

Referring to FIGS. 6 to 8, the main jointing rod 2 includes a through hole 20. The first end portion 51 of the induction coil 5 passes through the through hole 20 of the main jointing rod 2 firstly and then penetrates the top cover 60 of the notch filter 6 to be coupled to the printed circuit board 4. The through hole 20 ensures that a positioning purpose is formed between the induction coil 5 and the main jointing rod 2, and therefore, the induction coil 5 is prevented from shaking.

Referring to FIG. 6 and FIG. 8, the induction coil 5 is furthermore soldered on the main jointing rod 2 at a location of the through hole 20 through some solder paste. The soldering mode improves positioning stability between the induction coil 5 and the main jointing rod 2.

Referring to FIG. 6, the spiral body portion 50 is positioned in the notch filter 6 for realizing the effects of resonance and filtering.

Referring to FIG. 6 again, the spiral body portion 50 is arranged at a location which is ½ of the overall height of the notch filter 6, that is to say, the spiral body portion 50 is positioned at the middle section of the notch filter 6. According to the cavity depth, this present disclosure can be more convenient to replace the number of coils and diameter size, and therefore, an effect of resonant fluxes of different sizes can be realized.

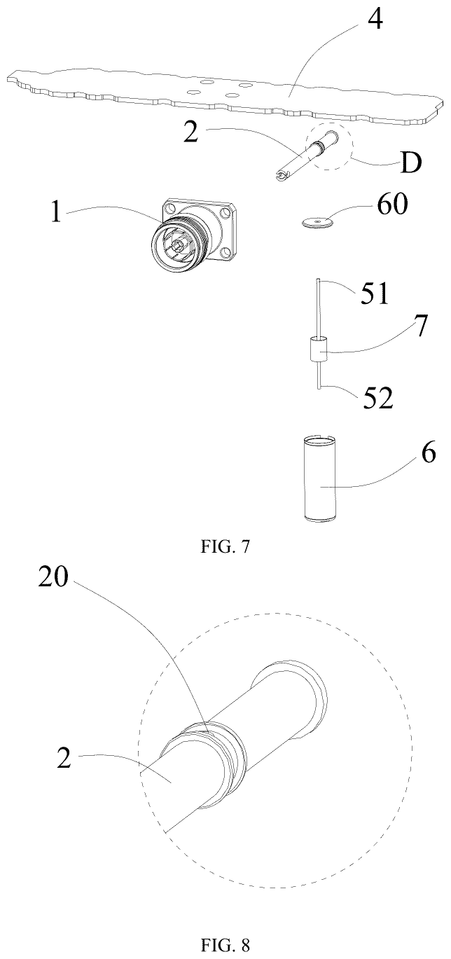

Referring to FIG. 6 and FIG. 7, the lightning protection structure of the present disclosure further includes a heat shrink tube 7. The heat shrink tube 7 is located in the notch filter 6 and the heat shrink tube 7 is wrapped outside the spiral body portion 50. The heat shrink tube 7 has a function which is that, the periphery of the induction coil 5 is insulated by the heat shrink tube 7 for preventing short circuit.

Referring to FIG. 7, the material of the notch filter 6 is metal, preferably an alloy made of two or more metals, and for example: copper-aluminum alloy. The conductivity of the notch filter 6 is guaranteed thereby.

Referring to FIG. 6 and FIG. 7, the inner core material of the antenna jointing interface 1 is brass silver-plated and the material of the main jointing rod 2 is copper silver-plated, so that a better conductivity of the antenna jointing interface 1 and a better conductivity of the main jointing rod 2 are both guaranteed, and furthermore, cost of the lightning protection structure is reduced thereby.

Referring to FIGS. 4 to 8, the material of the cavity filter cavity filter 3 is an aluminum alloy. For one hand, the cavity filter 3 which adopts aluminum alloy makes sure that the conductivity of the cavity filter 3 is guaranteed. For the other hand, the cavity filter 3 which adopts aluminum alloy makes sure that the cost of the lightning protection structure is reduced.

Referring to FIG. 6 and FIG. 7, the material of the induction coil 5 is enameled wire, for meeting the demand of conductivity.

The lightning protection principle of the present disclosure is that: because the inner core material of the antenna jointing interface 1 is brass-silver-plated and the material of the main jointing rod 2 is copper-silver-plated, the material of the cavity filter 3 is aluminum alloy, the material of the induction coil 5 is enameled wire, and the material of the notch filter 6 is metal. All of the above materials are conductors. After the induction coil 5 is soldered with the printed circuit board 4, the bottom wall which is opposite to the top cover 60 of the notch filter 6 and the circuit on the printed circuit board 4 form a grounding loop for lightning protection.

Compared to the related art, because of canceling the central column of the related art, an outer shell of the notch filter 6 in the present disclosure, which is pointed to other parts besides the top cover 60, is formed by a die and so the molding efficiency is improved compared with the bar turning processing in the related art. Therefore, the consistency of the notch filters 6 which are formed by the same batch of molds is more stable. Furthermore, the production yield is better, the processing efficiency is improved and the maintenance difficulty is reduced.

The present disclosure discloses a lightning protection structure which is adapted for the antenna end of a filter and the lightning protection structure positions the induction coil 5 in the notch filter 6 instead of positioning the central column in the notch filter 6. In other words, the induction coil 5 is used to replace the central column of the related art. Therefore, the present disclosure discloses a replaceable coil number and diameter size according to the cavity depth condition, realizes improving inductance value, resonance, flux size, can realize full band coverage. In other words, the present disclosure does not need to change a whole set of the notch filter 6 separately, versatility is stronger, and at the same time, replacement cost and maintenance cost are reduced indirectly.

The cavity space occupied by the notch filter 6 in the present disclosure is small, and an electronic device arrangement on the printed circuit board 4 is made flexible simultaneously, and a limited space above the printed circuit board 4 is reasonably utilized. In the case of carrier signal, receiving sensitivity and signal-to-noise ratio and suppressing unwanted frequency bands and the like, the lightning protection structure adapted for the antenna end of a filter, which is disclosed by the present disclosure, is more stable, consistent and stronger, the practicability is wider, the structure is simpler, the batch is easier, the electroplating yield is better, and the cost is lower.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A lightning protection structure, adapted for an antenna end of a filter, comprising:
a cavity filter;
an antenna jointing interface being located outside the cavity filter;
a main jointing rod;
a printed circuit board;
a notch filter; the main jointing rod, the printed circuit board and the notch filter being located in the cavity filter, the main jointing rod passing through a wall surface of the cavity filter, the main jointing rod being coupled to the antenna jointing interface, the printed circuit board and the notch filter being positioned at two opposite sides of the main jointing rod, respectively; and
an induction coil being arranged in the notch filter, the induction coil comprising a spiral body portion, a first end portion and a second end portion, the first end portion and the second end portion extending from the spiral body portion in opposite directions, the first end portion of the induction coil extending through a top cover of the notch filter, the first end portion of the induction coil being coupled to the printed circuit board, the second end portion of the induction coil being coupled to a bottom wall of the notch filter, and the notch filter being disposed opposite to the top cover.

2. The lightning protection structure according to claim 1, wherein the main jointing rod defines a through hole, the first end portion of the induction coil passes through the through hole of the main jointing rod, and the first end portion of the induction coil is coupled to the printed circuit board.

3. The lightning protection structure according to claim 2, wherein the induction coil is soldered on the main jointing rod at a location of the through hole via solder paste.

4. The lightning protection structure according to claim 1, wherein the spiral body portion is positioned in the notch filter.

5. The lightning protection structure according to claim 4, wherein the spiral body portion is arranged at a location which is half of an overall height of the notch filter.

6. The lightning protection structure according to claim 4, further comprising a heat shrink tube, wherein the heat shrink tube is located in the notch filter, and the heat shrink tube is wrapped around the spiral body portion.

7. The lightning protection structure according to claim 1, wherein the notch filter is made of a metal material.

8. The lightning protection structure according to claim 1, wherein a material of an inner core of the antenna jointing interface is silver-plated brass, and a material of the main jointing rod is copper-plated silver.

9. The lightning protection structure according to claim 1, wherein a material of the cavity filter is aluminum alloy.

10. The lightning protection structure according to claim 1, wherein a material of the induction coil is an enameled wire.

11. A lightning protection structure, adapted for an antenna end of a filter, comprising:
a cavity filter;
an antenna jointing interface being located outside the cavity filter;
a main jointing rod being located in the cavity filter, the main jointing rod passing through a wall surface of the cavity filter, and the main jointing rod being coupled to the antenna jointing interface;
a printed circuit board;
a notch filter; the printed circuit board and the notch filter being both located in the cavity filter, and being positioned at opposite sides of the main jointing rod, respectively; and
an induction coil being arranged in the notch filter, the induction coil comprising a spiral body portion, a first end portion and a second end portion, the first end portion and the second end portion extending from the spiral body portion in opposite directions, the first end portion of the induction coil extending through a top cover of the notch filter, the first end portion of the induction coil being coupled to the printed circuit board, the second end portion of the induction coil being coupled to a bottom wall of the notch filter, and the notch filter being disposed opposite to the top cover.

12. The lightning protection structure according to claim 11, wherein the main jointing rod defines a through hole, the first end portion of the induction coil passes through the through hole of the main jointing rod, and the first end portion of the induction coil is coupled to the printed circuit board.

13. The lightning protection structure according to claim 12, wherein the induction coil is soldered on the main jointing rod at a location of the through hole via solder paste.

14. The lightning protection structure according to claim 11, wherein the spiral body portion is positioned in the notch filter, and the spiral body portion is arranged at a location which is half of an overall height of the notch filter 6.

15. The lightning protection structure according to claim 14, further comprising a heat shrink tube, wherein the heat shrink tube is located in the notch filter, and the heat shrink tube is wrapped around the spiral body portion.

16. A lightning protection structure, adapted for an antenna end of a filter, comprising:
a cavity filter;
an antenna jointing interface being located outside the cavity filter;
a main jointing rod being located in the cavity filter, the main jointing rod passing through a wall surface of the cavity filter and the main jointing rod being coupled to the antenna jointing interface;
a printed circuit board being located in the cavity filter, and the printed circuit board being positioned at a first lateral side of the main jointing rod;
a notch filter being located in the cavity filter, and the notch filter being positioned at a second lateral side of the main jointing rod; the second lateral side of the main jointing rod being disposed opposite to the first lateral side of the main jointing rod; and
an induction coil being arranged in the notch filter, the induction coil comprising a spiral body portion, a first end portion and a second end portion, the first end portion extending from the spiral body portion in a first direction and the second end portion extending from the spiral body portion in a second direction opposite to the first direction, the first end portion of the induction coil extending through a top cover of the notch filter, the first end portion of the induction coil being coupled to the printed circuit board, the second end portion of the induction coil being coupled to a bottom wall of the notch filter, and the notch filter being disposed opposite to the top cover.

17. The lightning protection structure according to claim 16, wherein the main jointing rod defines a through hole, the first end portion of the induction coil passes through the through hole of the main jointing rod, and the first end portion of the induction coil is coupled to the printed circuit board.

18. The lightning protection structure according to claim 17, wherein the induction coil is soldered on the main jointing rod at a location of the through hole via solder paste.

19. The lightning protection structure according to claim 16, wherein the spiral body portion is positioned in the notch filter, and the spiral body portion is arranged at a location which is half of an overall height of the notch filter.

20. The lightning protection structure according to claim 19, further comprising a heat shrink tube, wherein the heat shrink tube is located in the notch filter and the heat shrink tube is wrapped around the spiral body portion.
